(19) United States
(12) Patent Application Publication
(10) Pub. No.: US 2002/0044338 A1
(43) Pub. Date: Apr. 18, 2002

(54) Apparatus and method for stabilizing an ultrashort optical pulse amplifier

(76) Inventors: David Ronald Walker, Ann Arbor, MI (US); Yang Pang, Ann Arbor, MI (US); Edward Frank Gabl, Saline, MI (US); Robert Maynard, Gregory, MI (US); Charles Bogusch, Ann Arbor, MI (US)

Correspondence Address: Stephen B. Salai, Esq., Harter, Secrest & Emery LLP, 1600 Bausch & Lomb Place, Rochester, NY, 14604-2711, US

(21) Appl. No.: 09/840,346

(22) Filed: Apr. 23, 2001

Related U.S. Application Data
(63) Continuation of application No. 08/434,735, filed on May 4, 1995, now abandoned.

(51) Int. Cl. H01S 3/04

(52) U.S. Cl. 359/337

(57) ABSTRACT

An apparatus for maintaining the temperature stability of an amplifier system comprises a device for heating, cooling or heating an cooling one or more sub-assemblies of the amplifier system, a temperature sensor for detecting variations in temperature of a sub-assembly, and a controller operably connecting the two. The signal from the sensor is used by the controller to adjust the amount of heating, cooling, or heating and cooling of a sub-assembly in order to maintain its temperature within a range sufficiently small to ensure stable performance.

This is a continuation of application Ser. No. 08/343,735 filed May 4, 1999.

### BACKGROUND

This investigation relates to an apparatus and method for stabilizing the thermally induced drift of an ultrashort optical pulse amplifier. Specifically, this invention relates to controlling the temperature of an ultrashort optical pulse amplifier system in order to maintain stable performance in an environment that is poorly regulated in temperature.

Many applications of ultrashort optical pulse amplifier systems (here we use amplifier system to mean either a regenerative amplifier system, a multipass amplifier system, or a system that combines aspects of both), require that their performance parameters be maintained within tight tolerances for long periods of time while they are being used to perform an specific function. The stability of these performance parameters becomes even more important when these ultrashort pulse amplifier systems are being used to pump other nonlinear devices like optical parametric amplifiers (OPA's), because OPA's are particularly sensitive to even minor changes in the pulse width, peak power, and/or beam pointing direction of the ultrashort optical pulse amplifier system being used to pump them.

The typical amplifier system consists of a number of sub-assemblies (by sub-assembly we mean the collection of reflective and/or refractive optical components, and their supporting and enclosing elements that, when taken together and properly oriented with respect to each other, perform a specific function). For example, the collection of reflective optics, prisms, gain medium, optical mounts, support structure and enclosure that function together to form the Ti:Sapphire oscillator part of the ultrashort optical pulse amplifier system is considered a sub-assembly of the ultrashort pulse amplifier system. Similarly, the collection of mirrors, grating(s), optical mounts, support structure, and enclosure that together function to stretch an input pulse width in time is typically referred to as a stretcher is also referred to as a sub-assembly. Further, the collection of mirrors, grating(s), optical mounts, support structure, and enclosure that function to compress an input pulse width in time is typically referred to as a compressor and is a sub-assembly.

Those skilled in the art will recognize that there are variations on the sub-assembly concept. For example, the support structure, such as a breadboard, base plate, or the like, and enclosure for the isolator, stretcher, regenerative amplifier, and compressor may be common to all the elements, or common to some combination thereof. Each such combination or sub-combination is also considered to be a sub-assembly. There is the oscillator that generates the ultrashort pulse that seeds the ultrashort optical pulse amplifier system. The oscillator is usually followed by a stretcher that is designed to stretch the pulse width of the seed pulse by factors as high as 10,000, so that upon amplification the energy density stays below the critical threshold at which self-focusing begins to overcome the natural divergence of the beam being amplified. In certain configurations multiple passes through the gain medium itself or other refractive materials may serve to stretch the seed pulse through group velocity dispersion, (GVD).

Following the stretcher there is the isolator section designed to shield the oscillator from the effects of light back scattered from the amplifier. The isolator also functions to direct light along different propagation paths depending on its polarization state. The amplifier itself consists of a number of optical elements, one or more optical switches, and a gain medium that absorbs light at the pump laser wavelength and exhibits gain at the seed pulse wavelength. There is also the pump source for the amplifier gain medium whose important characteristics are that it has an output wavelength substantially matching the absorption wavelength of the amplifier so as to produce gain at the seed pulse wavelength. And finally, there follows after the amplifier a compressor designed to recompress the amplified pulse width back to some acceptable final pulse width—usually close to the original pulse width of the seed pulse.

Typical amplifiers have as many as 60 optical components and an effective optical path length of tens of meters. Additionally, components associated with the amplifier, like the pump laser and the argon ion laser used to pump the seed oscillator, have associated electronics that dump heat into the local environment. These factors, combined with the fact that cost and performance considerations dictate the use of materials that have relatively high thermal coefficients of expansion (like aluminum and steel as compared with Invar or Superinvar), make amplifier systems highly sensitive to the small thermal fluctuations that exist in the typical laboratory environment in which they are operated. Particularly sensitive to thermal changes are the self-mode locked oscillator cavity, the pulse stretcher, and the pulse compressor assembly, because they are so often run in multipass geometries with long path lengths.

Accordingly, the inventor has recognized a need for method and equipment which reduces or eliminates thermally induces drift in performance in the sub-assemblies of amplifier systems to provide for stable operation over long periods of time.

### SUMMARY

It is an object of the present invention to control the temperature of some or all of the sub-assembly of an amplifier system.

It is a further object of the present invention to minimize thermally induced degradation in performance of an amplifier system.

An apparatus for maintaining the temperature stability of an amplifier system comprises a device for heating, cooling or heating and cooling one or more sub-assemblies of the amplifier system, a temperature sensor for detecting variations in temperature of a sub-assembly, and a controller operably connecting the two. The signal from the sensor is used by the controller to adjust the amount of heating, cooling, or heating and cooling of a sub-assembly in order to maintain its temperature within a range of sufficiently small to ensure stable performance.

In one aspect of the invention, one or more of the sub-assemblies of the amplifier system is maintained at a temperature that is elevated above that of the surrounding environment using a device for resistive heating that is affixed to it. The controller provides electrical current regulated in a manner that controls the heating and cooling of the sub-assembly and thereby stabilizes the performance of that portion of the system.

In another aspect of the invention, one or more of the sub-assemblies of the amplifier system is maintained at a constant temperature by controlling the temperature of a liquid that flows through the support structure or enclosure panels so as to maintain thermal stability, and in this manner stabilize performance.

In a third aspect of the invention, one or more of the sub-assemblies is maintained at a constant temperature by controlling its temperature using a thermoelectric cooler of the type known to those skilled in the art.

### BRIEF DESCRIPTION OF THE DRAWINGS

FIG. 1 is a schematic plan view of a typical amplifier system showing one arrangement of the sub-assemblies of the system.

FIG. 2 is a schematic plan of one of the sub-assemblies showing the presence of the controller, temperature sensor, and heater.

### DETAILED DESCRIPTION

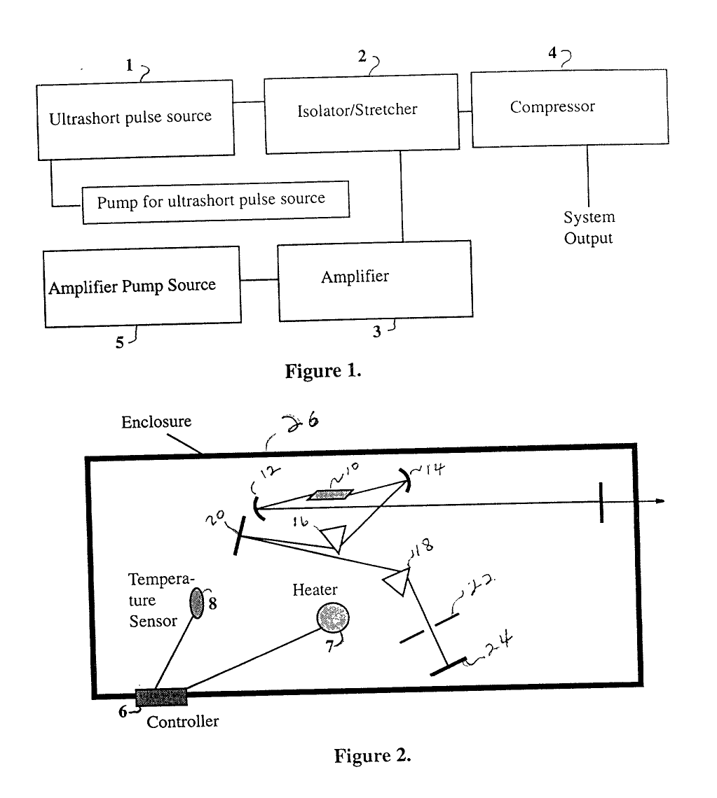

A preferred version of the invention is shown schematically in FIG. 1. A source of ultrashort pulses 1 consists of a number of optical components and mounts affixed to support structure and contained within an enclosure forming one of a number of sub-assemblies, of an amplifier system. Similar sub-assemblies are illustrated in FIG. 1 and marked as isolator/stretcher, 2, amplifier, 3, and compressor, 4. Each sub-assembly, or some combination thereof, comprises a number of optical components affixed to mounts which are in turn attached to some supporting member and surrounded by an enclosure. Each of these sub-assemblies, or a select sub-set of them (e.g. just the stretcher and compressor) may be thermally stabilized in order to minimize drift in performance that would adversely impact the utility of the system as a whole.

One way of accomplishing this active thermal stabilization is illustrated in FIG. 2. Shown therein is a generic sub-assembly (e.g. a self-mode-locked Ti:Sapphire laser oscillator of the type that might be used in the ultrashort optical pulse amplifier system in FIG. 1 and identified as sub-assembly 1,—whose components are schematically illustrated). The laser oscillator includes a gain medium 10 located within a cavity defined by first and second end mirrors 12 and 14. First and second prisms 16 and 18 are optically coupled to mirror 14 by mirror 20. A slit 22 and a mirror 24 may be used to tune the laser. All of these elements are preferably mounted on a base and enclosed within an enclosure 26. The view is looking down on the inside of the enclosure from the top with the top removed. Affixed to the side of the enclosure is a controller (e.g. Cole-Parmer Model #H-89800-00), 6, operably connected to a thermal sensor (J-type), 7, attached to the support structure (e.g. base plate), 8. Also affixed to the support structure, 8, is the heat resistor (e.g. Allied Electric Model 895-0456), 9, which is also operably connected to the controller, 6.

Functionally, the controller is set to stabilize the temperature of the sub-assembly, and especially the temperature of the support structure, with a limited range of temperature variation such as 0.1-0.3° F. about an average value above the range of variation in temperatures in the environment. Thus, conductive and radiative cooling into the cooler surrounding environment serves as means to lower the temperature of the sub-assembly. When the controller senses that the temperature has drifted downward to the point where it is no longer within the lower end of a preset value, it will apply a current to the resistive heater affixed to the sub-assembly, and in so doing raise its temperature to bring it back within range. This temperature rise increases until it reaches another preset value, at which point the controller turns off the current to the heater attached to the support structure. In this manner, the temperature of a sub-assembly can be kept within a preset range that will stabilize performance of the amplifier system.

The foregoing description of the invention is intended to be merely exemplary of the invention and those skilled in the art will appreciate that certain changes and modifications to the method and apparatus described above are well within the scope of the invention which is solely defined by the appended claims.

What is claimed:

1. A regenerative amplifier system for a laser, the amplifier system including a regenerative amplifier enclosed in a housing located with an environment having ambient temperature that varies within a first range, the amplifier system comprising:
a sensor for determining the temperature of the regenerative amplifier;
a heater/cooler coupled to the regenerative amplifier for varying the temperature of the sub-assembly within the housing; and
a controller operably connected between said sensor and the heater/cooler for controlling the heater/cooler to maintain the temperature of the regenerative amplifier within a temperature range smaller than the first range to maintain performance of the amplifier system within acceptable limits.

2. The regenerative amplifier system of claim 1 in which the regenerative amplifier comprises one or more of the elements consisting of an isolator, a stretcher, an amplifier or amplifiers, and a compressor.

3. The regenerative amplifier system of claim 1 in which the heater/cooler comprises one or more elements selected from the group of devices consisting of a heating element of the resistive type, a liquid whose temperature is raised or lowered and a thermo-electric cooler.

4. The regenerative amplifier system of claim 1 further comprising an amplifier gain medium of a solid-state material.

5. The regenerative amplifier system of claim 4 in which the amplifier gain medium is selected from among the following choices: Ti:Sapphire, Alexandrite, Forsterite, Li:SAF, Li:SGAF, Erbium-doped fiber, Nd-doped fiber, Holium, Nd:Glass, Nd:YAG, Nd.YLF, or Cr:YAG.

6. The regenerative amplifier system of claim 2 in which the heater/cooler comprises one or more of the elements selected from the group of devices consisting of a heating element of the resistive type, a liquid whose temperature is raised or lowered and a thermo-electric cooler.

7. The regenerative amplifier system of claim 2 further comprising an ultra short pulse amplifier gain medium of a solid-state material.

8. The regenerative amplifier system of claim 7 in which the ultrashort pulse amplifier gain medium is selected from among the following choices: Ti:Sapphire, Alexandrite, Forsterite, Li:SGAF, Erbium-doped fiber, Nd-doped fiber, Holium, Nd:Glass, Nd:YAG, Nd.YLF, or Cr:YAG.

9. A method for maintaining the performance of a regenerative amplifier sub-system within a desired range comprising the steps of:
disposing a regenerative amplifier of the regenerative amplifier sub-system in an environment having an ambient temperature that varies within a first range;
determining a temperature of the regenerative amplifier sub-system; and
varying the temperature of the regenerative amplifier sub-system to keep the temperature of the regenerative amplifier sub-system within a limited range smaller than the first range.

10. The 1method of claim 9 further comprising employing a gain medium selected from the group consisting of: Ti:Sapphire, Alexandrite, Forsterite, Li:SAF Li:SGAF, Erbium doped fiber, Nd-doped fiber, Holium, Nd:Glass, Nd:YAG, Nd.YLF, or Cr:YAG.

11. A laser amplifier system located within an environment having ambient temperature that varies within a first range comprising:
(a) a support structure, a pulse compressor comprising a plurality of elements attached to the support structure, separated by a distance that varies with temperature;
(b) a sensor for determining the temperature of the support structure;
(c) a heater/cooler coupled to the support structure for varying the temperature of the support structure; and
(d) a controller operably connected between the sensor and the heater/cooler for controlling the heater/cooler to maintain the temperature of the support structure within a temperature range smaller than the first range to maintain the distance between the elements of the pulse compressor within acceptable limits.

12. The laser amplifier system of claim 11 in which the heater/cooler comprises one or more elements selected from the group of devices consisting of a heating element of the resistive type, a liquid whose temperature is raised or lowered and a thermo-electric cooler.

13. The laser amplifier system of claim 11 further comprising a solid state gain medium.

14. The laser amplifier system of claim 13 in which the gain medium is selected from the group consisting of: Ti:Sapphire, Alexandrite, Forsterite, Li:SAF Li:SAF, Erbium doped fiber, Nd-doped fiber, Holium, Nd:Glass, Nd:YAG, Nd.YLF, or Cr:YAG.

15. The laser amplifier system of claim 13 in which the heater/cooler comprises one or more elements selected form the group of devices consisting of a heating element of the resistive type, a liquid whose temperature is raised or lowered and thermo-electric cooler.

16. The laser amplifier system of claim 14 in which the heater/cooler comprises one or more elements selected from the group of devices consisting of a heating element of the resistive type, a liquid whose temperature is raised or lowered and a thermo-electric cooler.

17. A laser amplifier system located within an environment having ambient temperature that varies within a first range comprising:
(a) a support structure, a mode locked oscillator comprising a plurality of elements attached to the support structure, separated by a distance that varies with temperature;
(b) a sensor for determining the temperature of the support structure;
(c) a heater/cooler coupled to the support structure for varying the temperature of the support structure; and
(d) a controller operably connected between the sensor and the heater/cooler for controlling the heater/cooler to maintain the temperature of the support structure within a temperature range smaller than the first range to maintain the distance between the elements of the pulse compressor within acceptable limits.

18. The laser amplifier system of claim 17 in which the heater/cooler comprises one or more elements selected from the group of devices consisting of a heating element of the resistive type, a liquid whose temperature is raised or lowered and a thermo-electric cooler.

19. The laser amplifier system of claim 17 further comprising a solid state gain medium.

20. The laser amplifier system of claim 19 in which the gain medium is selected from the group consisting of: Ti:Sapphire, Alexandrite, Forsterite, Li:SAF Li:SGAF, Erbium doped fiber, Nd-doped fiber, Holium, Nd:Glass, Nd:YAG, Nd:YLF, or Cr:YAG.

21. The laser amplifier system of claim 20 in which the heater/cooler comprises one or more elements selected from the group of devices consisting of a heating element of the resistive type, a liquid whose temperature is raised or lowered and a thermo-electric cooler.

22. The laser amplifier system of claim 21 in which the heater/cooler comprises one or more elements selected from the group of devices consisting of a heating element of the resistive type, a liquid whose temperature is raised or lowered and a thermo-electric cooler.

23. A laser amplifier system located within an environment having ambient temperature that varies within a first range comprising:
(a) a regenerative amplifier cavity comprising a support surface and a plurality of elements attached to the support structure, the plurality of elements separated by a distance that varies with temperature;
(b) a sensor determining the temperature of the support structure;
(c) a heater/cooler coupled to the support structure for varying the temperature of the support structure; and
(d) a controller operably connected between the sensor and the heater/cooler for controlling the heater/cooler to maintain the temperature of the support structure within a temperature range smaller than the first range to maintain the distance between the elements of the regenerative amplifier cavity within acceptable limits.

24. The laser amplifier system of claim 23 in which the heater/cooler comprises one or more elements selected from the group of devices consisting of a heating element of the resistive type, a liquid whose temperature is raised or lowered and a thermo-electric cooler.

25. The laser amplifier system of claim 23 further comprising a solid state gain medium.

26. The laser amplifier system of claim 25 in which the gain medium is selected from the group consisting of: Ti:Sapphire, Alexandrite, Forsterite, Li:SAF Li:SGAF, Erbium doped fiber, Nd-doped fiber, Holium, Md:Glass, Nd:YAG, Md.YLF, or Cr:YAG.

27. The laser amplifier system of claim 25 in which the heater/cooler comprises one or more elements selected from the group of devices consisting of a heating element of the resistive type, a liquid whose temperature is raised or lowered and a thermo-electric cooler.

28. The laser amplifier system of claim 26 in which the heater/cooler comprises one or more elements selected from the group of devices consisting of a heating element of the resistive type, a liquid whose temperature is raised or lowered and a thermo-electric cooler.

29. A method for maintaining the performance of a laser amplifier that includes a support structure, a pulse compressor comprising a plurality of elements attached to the support structure, the plurality of elements separated by a distance that varies with temperature within a first temperature range, the method comprising the steps of:
determining a temperature the support structure; and
varying the temperature of a heater/cooler attached to the support structure to keep the support structure within a limited temperature range smaller than the first temperature range.

30. A method for maintaining the performance of a laser amplifier that includes a support structure, a mode locked oscillator comprising a plurality of elements attached to the support structure, the plurality of elements separated by a distance that varies with temperature within a first temperature range, the method comprising the steps of:
determining the temperature of the support structure; and
varying the temperature of a heater/cooler attached to the support structure to keep the support structure within a limited temperature range smaller than the first temperature range.

31. A method for maintaining the performance of a laser amplifier that includes a support structure, a regenerative amplifier of the mode locked type comprising a plurality of elements attached to the support structure, the plurality of elements separated by a distance that varies with temperature within a first temperature range, the method comprising the steps of:
determining the temperature of the support structure; and
varying the temperature of a heater/cooler attached to the support structure to keep the support structure within a limited range temperature smaller than the first temperature range.
